(19) United States
(12) Patent Application Publication
(10) Pub. No.: US 2016/0086087 A1
(43) Pub. Date: Mar. 24, 2016

(54) METHOD FOR FAST PREDICTION OF GAS COMPOSITION

(71) Applicant: King Fahd University of Petroleum and Minerals, Dhahran (SA)

(72) Inventor: Lahouari GHOUTI, Dhahran (SA)

(73) Assignee: King Fahd University of Petroleum and Minerals, Dhahran (SA)

(21) Appl. No.: 14/491,373

(22) Filed: Sep. 19, 2014

(51) Int. Cl. G06N 5/04; G06N 99/00

(52) U.S. Cl. CPC G06N 5/04; G06N 99/005

(57) ABSTRACT

A method and device for predicting a gas composition, including pre-processing, by non-negative matrix factorization, a set of input parameters related to a fluid mixture of hydrocarbons and non-hydrocarbons fed into a multistage separator, and training an extreme learning machine model to predict the composition of non-hydrocarbons in the fluid mixture.

### BACKGROUND

1. Field of the Invention

The present invention relates to a method and device for predicting gas compositions in a multistage separator, particularly using an extreme learning machine in combination with an optimal feature extractor based on non-negative matrix decomposition (NMF) algorithms.

2. Description of the Related Art

The “background” description provided herein is for the purpose of generally presenting the context of the disclosure. Work of the presently named inventor, to the extent it is described in this background section, as well as aspects of the description which may not otherwise qualify as prior art at the time of filing, are neither expressly nor impliedly admitted as prior art against the present invention.

The prediction of non-hydrocarbon components in gas compositions is a challenging task, in part because the amounts of non-hydrocarbon components are typically small and are treated as impurities in the gas compositions. Small quantities of non-hydrocarbon components may be strongly influenced by changes in temperature and pressure, and there are no straightforward analytical solutions to predict these small quantities. In the petroleum engineering field, correlation- and statistical-based methods typically have been used to predict hydrocarbon quantities in gas compositions. However, such approaches face challenges mainly related to the irregularity of the data involved in the prediction process.

Machine learning-based prediction techniques are well suited to handle noisy statistical fluctuations inherent in such data. For example, computational intelligence techniques, such as artificial neural network (ANNs), can be used to predict various properties of fluid compositions in petroleum reservoirs, such as viscosity, porosity, permeability, and pressure-volume-temperature (PVT) relationships. The underlying models of such prediction problems are quite elaborate since petroleum gas, or natural gas, is modeled as hydrocarbons mixed with varying amounts of non-hydrocarbons. Similarly, oil reservoirs are typically in the form of a sponge-like rock with interconnected open spaces between grains, typically found approximately a kilometer underground. The prediction of fluid properties in gas compositions in multistage separators is even more challenging, especially when access to observation/measurement data is costly and/or time-consuming. In such cases, machine learning approaches are well suited to address the problems of data scarcity and dimensionality.

Capacity and efficiency of gas/liquid separation are of great concern in natural gas production. Oil resides in reservoirs at great temperatures and pressures, on the order of 5,000 psi and approximately 250° F. After the oil is extracted from a reservoir, it is collected in sequential multistage separator tanks at much lower temperatures and pressures, typically on the order of approximately 175 psi and 150° F. An exemplary multistage separator is shown in FIG. 1. The reservoir oil initially resides within the reservoir R. In the first stage, the oil is extracted and held in the first-stage separator, where gas is separated from the oil, and the extracted gas G1 is collected in a tank or the like. Moving through each stage, more gas is extracted from the oil as temperature and pressure are steadily decreased. In FIG. 1, once the gas G1 has been extracted, the oil is transferred to the second-stage separator, where further separation is performed. Second-stage gas G2 is extracted at a pressure on the order of approximately 100 psi and a temperature of approximately 100° F. The oil is then passed to a third-stage separator, where third-stage gas G3 is separated at a pressure on the order of approximately 14.7 psi and a temperature of approximately 60° F. Although a three-stage separator is shown in FIG. 1, it should be understood that this is for exemplary purposes only, and that a multistage reactor may have many more intermediate stages.

### SUMMARY OF THE INVENTION

The foregoing paragraphs have been provided by way of general introduction, and are not intended to limit the scope of the following claims. The described embodiments, together with further advantages, will be best understood by reference to the following detailed description taken in conjunction with the accompanying drawing.

The method of predicting gas compositions relates to predicting gas composition in a multistage separator. Particularly, solutions to the regression problem of gas composition prediction are developed using extreme learning machines (ELMs) for defining the optimal predictor weights and non-negative matrix factorization to extract parts-based features from a set of properties of a reservoir.

One aspect of the present invention includes a method of predicting a gas composition, comprising the steps of:

(a) receiving a set of input parameters related to a fluid mixture of hydrocarbons and non-hydrocarbons fed into a multistage separator;

(b) pre-processing the set of input parameters by non-negative matrix factorization, to obtain a reduced feature set;

(c) providing a training dataset comprising the reduced feature set;

(d) randomly selecting a first set percentage of the training dataset;

(e) training an extreme learning machine model with the selected first set percentage of the training dataset;

(f) predicting a mole percentage of the non-hydrocarbons in the fluid mixture;

(g) comparing the predicted mole percentage with the set of input parameters, and selecting a second set percentage of badly predicted training datasets based upon a pre-set threshold error value; and

(h) repeating (b) through (g) one or more times on the second set percentage of badly predicted training datasets, using one or more factorization levels in the non-negative matrix factorization. One or more of steps (a) through (h) may be performed with a processor or circuitry programmed with instructions.

In another aspect of the method of predicting a gas composition, the input parameters comprise at least one member selected from the group consisting of a reservoir temperature, a reservoir pressure, a reservoir gas composition, a separator stage temperature and a separator stage pressure.

In another aspect of the method of predicting a gas composition, the non-hydrocarbons comprise at least one member selected from the group consisting of N₂, CO₂ and H₂S.

Another aspect of the present invention includes a gas composition predicting device, comprising:

an interface; and circuitry configured to

(a) receive a set of input parameters related to a fluid mixture of hydrocarbons and non-hydrocarbons fed into a multistage separator via the interface;

(b) pre-process the set of input parameters by non-negative matrix factorization, to obtain a reduced feature set;

(c) provide a training dataset comprising the reduced feature set;

(d) randomly select a first set percentage of the training dataset;

(e) train an extreme learning machine model with the selected first set percentage of the training dataset;

(f) predict a mole percentage of the non-hydrocarbons in the fluid mixture;

(g) compare the predicted mole percentage with the set of input parameters, and select a second set percentage of badly predicted training datasets based upon a pre-set threshold error value; and

(h) repeat (b) through (g) one or more times on the second set percentage of badly predicted training datasets, using one or more factorization levels in the non-negative matrix factorization. One or more of steps (a) through (h) may be performed with a processor.

In another aspect of the gas composition predicting device, the input parameters comprise at least one member selected from the group consisting of a reservoir temperature, a reservoir pressure, a reservoir gas composition, a separator stage temperature and a separator stage pressure.

In another aspect of the gas composition predicting device, the non-hydrocarbons comprise at least one member selected from the group consisting of N₂, CO₂ and H₂S.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram of an exemplary multistage separator.

FIG. 2 is a diagram illustrating a multi-layer perceptron (MLP) artificial neural network (ANN).

FIG. 3 is a diagram illustrating a neuron with a sigmoidal activation function.

FIG. 4 is a diagram illustrating an exemplary MLP structure for predicting CO₂.

FIG. 5 is a diagram illustrating a representation of an extreme learning machine.

FIG. 6 is a diagram illustrating features extracted from a database of numeric digits using the top 20 vectors using principal component analysis (PCA) (left) and non-negative matrix factorization (NMF) (right).

FIG. 7 is a diagram illustrating features extracted from the same database of numeric digits as in FIG. 6, using the top 50 vectors using PCA (left) and NMF (right).

FIG. 8 is a schematic diagram of a method for the fast prediction of gas compositions according to an embodiment of the invention.

FIG. 9 is a schematic diagram of a computer system upon which an embodiment of the present invention may be implemented.

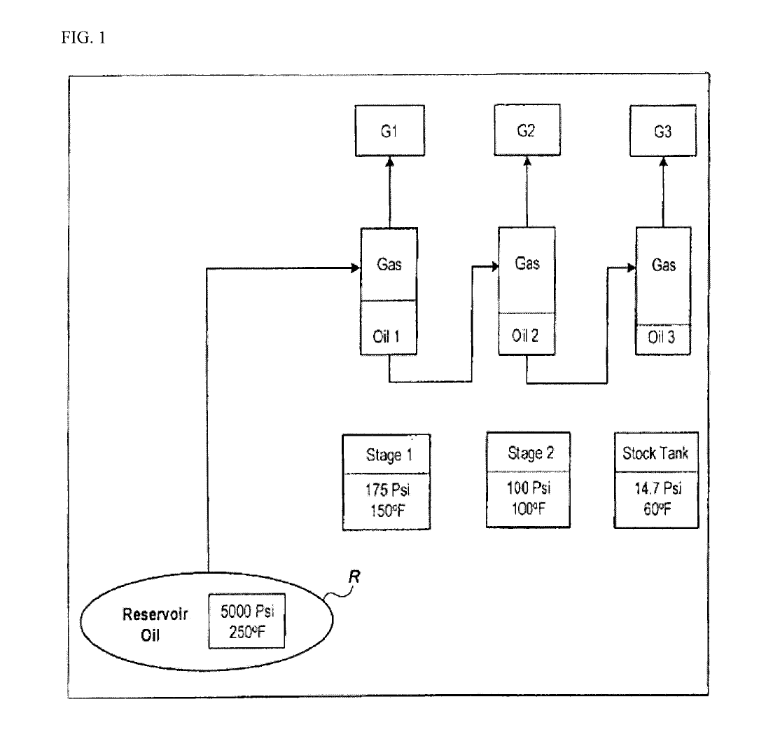

### DETAILED DESCRIPTION OF THE INVENTION

A common complication that occurs in quantifying the behavior of multiphase flows is that under high pressure, the properties of the mixture may differ considerably from those of the same mixture at atmospheric pressure. For example, under pressure, extracted gas may still contain liquid and solid constituents. The removal of these constituents forms the most important process step before delivery can take place. The liquids almost invariably consist of water and hydrocarbons that are gaseous under reservoir conditions, but which condense during production due to the decrease in gas pressure and temperature. Mixtures of non-hydrocarbons, such as N₂, CO₂ and H₂S, are not desirable in the remaining stock tank oil, and removal of such non-hydrocarbons requires a great deal of additional energy and effort. Thus, accurate and efficient prediction of the quantities of the non-hydrocarbons would greatly facilitate the multistage separation process.

Typically in the petroleum industry, the equation of state (EOS) and empirical correlations (EC) are used to predict oil and gas properties, along with basic artificial intelligence (AI). For example, the Chevron Phase Calculation Program (CPCP) is a typical program that is based on EOS and EC. CPCP is a program designed to help an engineer calculate the phase compositions, densities, viscosities, thermal properties, and the interfacial tensions between phases for liquids and vapors in equilibrium. The program takes reservoir gas compositions, C7+ molecular weight and density, and separator stage temperature and pressure as input, and then predicts gas compositions of that stage as output using EOS and EC.

EOS is useful for a description of fluid properties, such as PVT, but there is no single EOS that accurately estimates the properties of all substances under all conditions. The EOS has adjustment issues against the phase behavior data of reservoir fluids of known composition, while the EC has only limited accuracy. In recent years, computational intelligence (CI) techniques, such as ANN, have gained popularity in solving various petroleum related problems, such as PVT, porosity, permeability, and viscosity prediction.

In one such technique, a multi-layer perceptron (MLP) with one hidden layer and a sigmoid activation function was used for the establishment of a model capable of learning the complex relationship between the input and the output parameters to predict gas composition. The ANN is a machine learning approach inspired by the way in which the human brain performs a particular learning task. ANN is composed of simple elements operating in parallel. These elements are inspired by biological nervous systems.

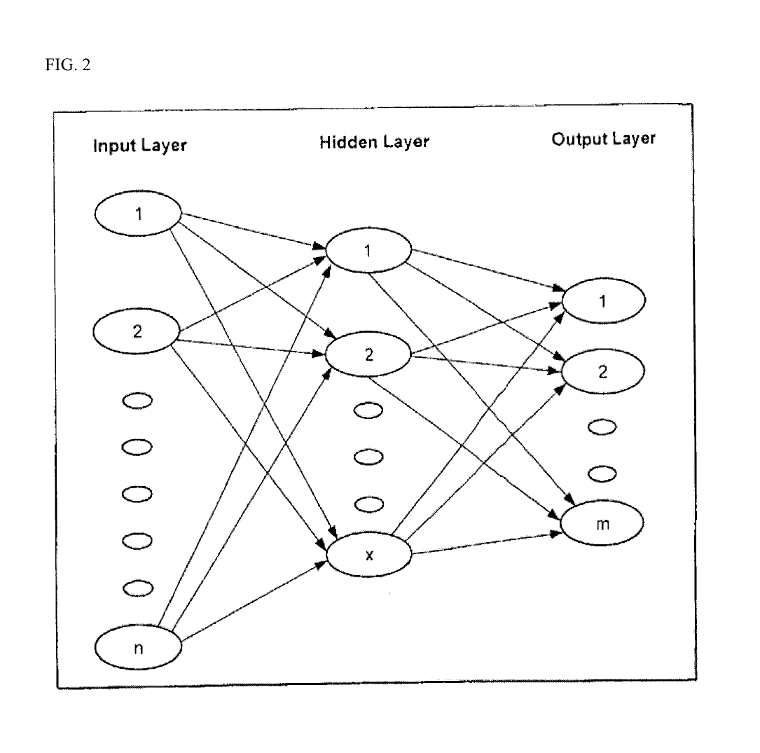

MLP, illustrated in FIG. 2, is a popular type of ANN. MLP has one input layer, one output layer, and one or more hidden layers of processing units. MLP has no feedback connections. The hidden layers sit between the input and output layers, and are thus hidden from the outside world, as shown in FIG. 2. The MLP can be trained to perform a particular function by adjusting the values of the connections (weights) between elements. Typically, MLP is adjusted, or trained, so that a particular input leads to a specific target output. The weights are adjusted, based on a comparison of the output and the target, until the network output matches the target. Typically, many such input/target pairs are needed to train a network.

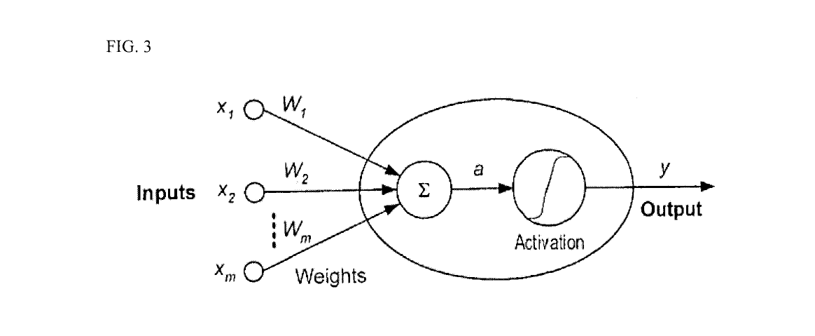

FIG. 3 illustrates a neuron with a sigmoidal activation function, where

$$a = {\sum }_{j = 1}^{m} {x}_{j} ( n ) {w}_{j} ( n ) and y = σ ( a ) = \frac{1}{( 1 + {e}^{- a} )} ,$$

where xⱼ represent the inputs, wⱼ represent the weights for each of the n inputs, and y represents the output of the neuron. In the technique for ANN component prediction noted above, each non-hydrocarbon component is predicted separately. One hidden layer is used for each non-hydrocarbon component. The configuration used for prediction of N₂, CO₂ and H₂S is shown below in Table 1:

TABLE 1
MLP Structure for each component

| | Hidden Layer | Hidden Layer | Outer Layer |
|---|---|---|---|
| Gas | Nodes | Activation Function | Activation Function |
| N₂ | 37 | logsig | tansig |
| O₂ | 37 | logsig | tansig |
| H₂S | 80 | logsig | tansig |

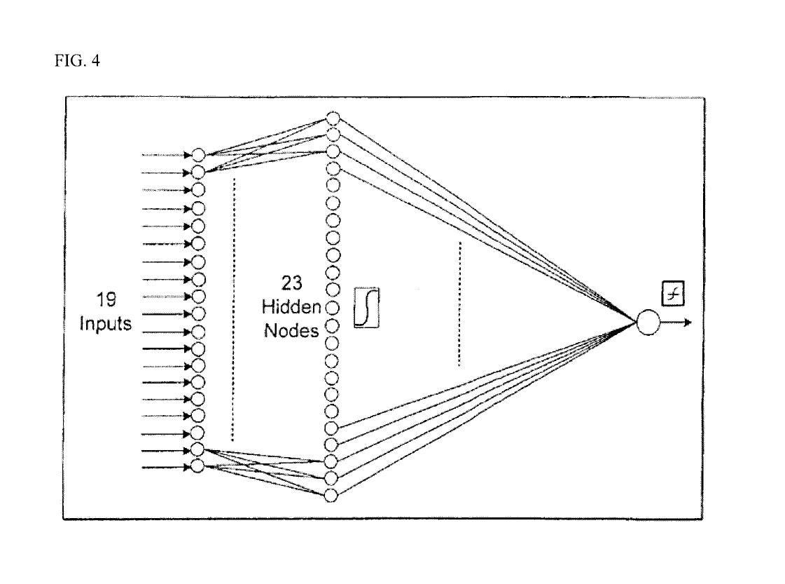

The training algorithm “Levenberg-Marquardt” was used for predicting N₂ and H₂S, while “Resilient Back propagation” (Rprop) was used for predicting CO₂. The other parameters that were used for MLP were Epochs, which was 300, a learning rate of 0.001 and a goal set to 0.00001. The MLP structure for predicting CO₂ is shown in FIG. 4.

Petroleum deposits are naturally mixtures of organic compounds consisting mainly of non-hydrocarbons and hydrocarbons. The deposit that is found in the gaseous form is called “natural gas”, and that found in the liquid form is called “crude oil”. For the ANN prediction technique, the input parameter consists of a mole percent of non-hydrocarbons, such as N₂, H₂S and CO₂, and hydrocarbons, such as methane (C1), ethane (C2), propane (C3), butane (C4), pentane (C5), hexane (C6), and heptanes and heavier hydrocarbons (C7+). The other input parameters are stock tank API, BPP, reservoir temperature, and separator pressure and temperature. In addition to the above, there are also isomers of C4 and C5. Above C7 components are considered as C7+. Molecular weight and density parameters of C7+ components are also given as input parameters. The non-hydrocarbons are of greater interest, as noted above. Thus, the output parameters include mole fractions of N₂, CO₂ and H₂S. To increase the number of training samples, the Stage 1 and Stage 2 oil compositions were calculated from the available data using the material balance method. 70% of samples taken were randomly chosen for training, and the remaining 30% of samples taken were used for validation and testing.

For machine learning-based prediction methods, such ANN, common techniques for performance evaluation include the correlation coefficient (CC) and the root mean squared error (RMSE). The CC measures the statistical correlation between the predicted and the actual values. This method is unique, in that it does not change with a scale in values. The value “1” means perfect statistical correlation and a value of “0” means no correlation at all. A higher number represents better results. This performance measure is only used for numerical input and output. The CC is calculated using the formula

$$\frac{\sum ( x - {x}^{′} ) ( y - {y}^{′} )}{\sqrt{\sum {( x - {x}^{′} )}^{2} \sum {( y - {y}^{′} )}^{2}}} ,$$

where x and y are the actual and the predicted values, and x′ and y′ are the mean of the actual and predicted values, respectively.

The RMSE is one of the most commonly used measures of success for numeric prediction. This value is computed by taking the average of the squared differences between each predicted value xₙ and its corresponding actual value yₙ. The RMSE is simply the square root of the mean squared error. The RMSE gives the error value with the same dimensionality as the actual and predicted values. It is calculated as

$$\sqrt{\frac{{( {x}_{1} - {y}_{1} )}^{2} + {( {x}_{2} - {y}_{2} )}^{2} + … + {( {x}_{n} - {y}_{n} )}^{2}}{n}} ,$$

where n is the size of the data.

The training and prediction time of the machine learning-based prediction technique is simply (T2−T1), where T2 is the CPU time at the end of the prediction and T1 is the CPU time at the beginning of training. Training time is measured to observe how long the model requires for training, and the prediction time shows how fast the model can predict the test data. When compared against CPCP, the MLP ANN method described above was found to achieve higher prediction accuracy with a lower RMSE and a higher CC value for N₂ and H₂S. CPCP was found to perform relatively well against the MLP ANN method for CO₂. Further, the MLP technique needs a very long time for training and takes a great deal of computational power and time. Thus, it would be desirable to have a machine learning-based approach that achieves higher prediction accuracy at faster learning speeds. Also, to achieve better prediction accuracy, the MLP parameters need to be tuned as well. Thus, it would be desirable to be able to propose a machine learning-based approach that does not resort to parameter tuning while learning the underlying model of the data being processed.

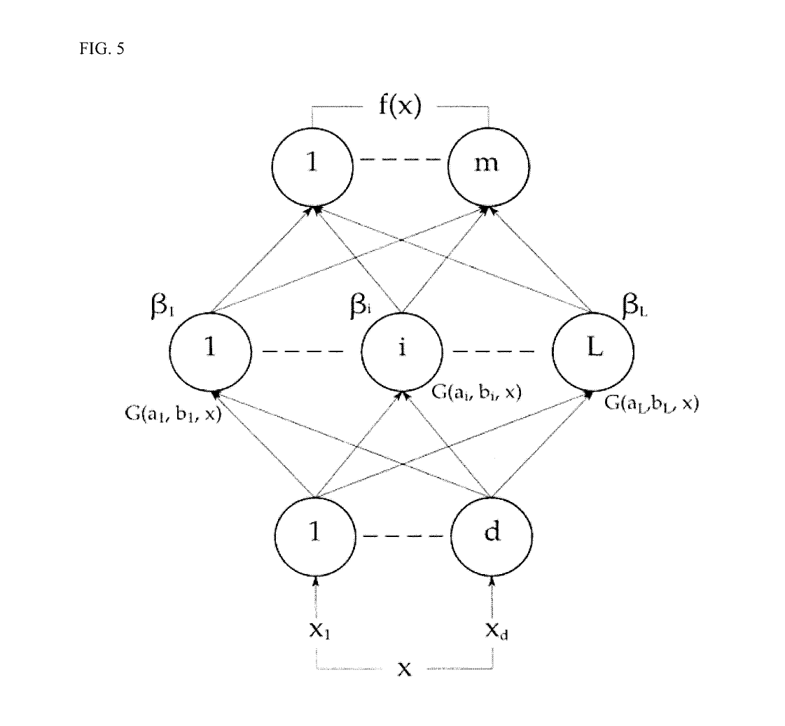

Unlike MLPs, extreme learning machines (ELMs) are single-layer feedforward networks (SLFNs) that do not require parameter tuning and yield network weights through a closed-form solution of a linear system of equations. Moreover, ELMs are considered as generalizations of SLFNs where the network structure is not required to be neuron-like. Also, unlike conventional SLFNs, ELMs apply random computational nodes in the hidden layer independently of the training data. In this way, ELMs do not achieve smaller training error but also the smallest norm of output weights. Using fixed parameters in the hidden layer, ELMs compute the output weights using a least-square solution. FIG. 5 illustrates a typical representation of ELMs.

The output function of the ELMs, shown in FIG. 5, is given by:

$${f}_{L} ( x ) = {\sum }_{i = 1}^{L} {β}_{i} {g}_{i} ( x )$$

where xε [symbol] ^{d}, βᵢε [symbol] ^{m} and the output of the ith hidden node, G(aᵢ, bᵢ, x), is given by gᵢ. Depending on the node type being an additive or radial basis function (RBF), the outputs are given by:

gᵢ(x)=G(aᵢ,bᵢ,x)=g(aᵢ·x+bᵢ)

gᵢ(x)=G(aᵢ,bᵢ,x)=g(bᵢ∥x−aᵢ∥)

Using N arbitrary distinct samples, (xᵢ,tᵢ)ε [symbol] ^{d}×R^{m}, the solution of the output weights is given by:

$$[ \begin{matrix}G ( {a}_{1} , {b}_{1} , {x}_{1} ) & … & G ( {a}_{L} , {b}_{L} , {x}_{1} ) \\ ⋮ & … & ⋮ \\ G ( {a}_{1} , {b}_{1} , {x}_{N} ) & … & G ( {a}_{L} , {b}_{L} , {x}_{N} )\end{matrix} ] [ \begin{matrix}{β}_{1}^{T} \\ ⋮ \\ {β}_{L}^{T}\end{matrix} ] = [ \begin{matrix}{t}_{1}^{T} \\ ⋮ \\ {t}_{N}^{T}\end{matrix} ]$$

The hidden layer output matrix of the ELMs model is given by:

$$H = [ \begin{matrix}G ( {a}_{1} , {b}_{1} , {x}_{1} ) & … & G ( {a}_{L} , {b}_{L} , {x}_{1} ) \\ ⋮ & … & ⋮ \\ G ( {a}_{1} , {b}_{1} , {x}_{N} ) & … & G ( {a}_{L} , {b}_{L} , {x}_{N} )\end{matrix} ]$$

The output of the ith hidden node to the input vector, (xᵢ, x₂, . . . , x_{N}), is given by the ith column of the hidden matrix H. The hidden layer feature mapping is given by G(aᵢ, b₁, x), . . . , G(a_{L}, b_{L}, x) and the hidden layer feature mapping with respect to the ith input, xᵢ, is defined as: G(aᵢ, b₁, xᵢ), . . . , G(a_{L}, b_{L}, xᵢ). For an infinitely differentiable activation function, the hidden layer parameters can be randomly generated (G. Huang, Q. Zhu, C. Siew, “Extreme learning machine: theory and applications,” Neurocomputing, vol. 70, no. 1, pp. 489-501, 2006—incorporated herein by reference in its entirety). The smallest norm least-squares solution of the linear system, given above, is:

[symbol]

=H⁺T

where H⁺ is the Moore-Penrose generalized inverse of matrix H and T is given by:

T=[t₁^{T},t₂^{T}, . . . ,T_{N}^{T}]^{T}

Given a training set [symbol] ={(xᵢ,tᵢ)|xᵢε [symbol] ^{d}, tᵢε [symbol] ^{m}, i=1, 2, . . . , N}, a hidden node output function, G(aᵢ, bᵢ, x), and the number of hidden nodes, L, the algorithm for the computation of the ELMs weights is summarized below:

1) Randomly generate hidden node parameters (aᵢ, bᵢ), i=1, 2, . . . , L.

2) Calculate the hidden layer output matrix H.

3) Calculate the output weight vector \hat{β} using the solution of the system defined above.

It should be noted that the singular value decomposition (SVD) is used to compute the Moore-Penrose generalized inverse of matrix H. Also, unlike other learning algorithms, ELMs can handle a wide type of activation functions including threshold networks.

In recent years, there has been a growing interest in deploying robust statistical and factorization techniques to extract robust features especially in the case of data scarcity. This is commonly known as the curse of dimensionality where the number of features used approximates the number of data samples available. Unlike principal component analysis (PCA), non-negative matrix factorization (NMF) yields a natural factorization of the features used to represent a reservoir's properties by restricting the factored elements to non-negative representations. Non-negative factorizations refer to constrained optimization formulations that result in non-negative (and possibly sparse) feature representations which can boost the prediction accuracy (see D. D. Lee and H. S. Seung, “Algorithms for non-negative matrix factorization,” Proceedings of Advances in neural information processing systems, pp. 556-562, 2001—incorporated herein by reference in its entirety).

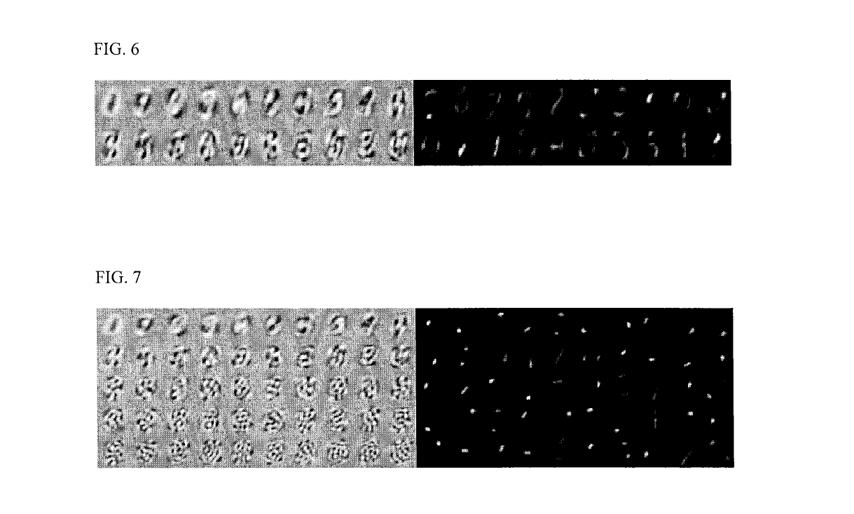

Further, PCA extracts whole features that may not lead to valid physical representations. On the other hand, NMF is capable of extracting part-based features. FIG. 6 shows the features extracted from a database of numeric digits using the top 20 vectors using PCA (left) and NMF (right) decomposition. It is clear that the NMF is capable of capturing the strokes that primarily characterize the numeric digits. To further show this property, features extracted from the same database using the top 50 vectors using PCA (left) and NMF (right) decomposition are shown in FIG. 7. In this case, the local features (parts-based) are even more pronounced in the case of the NMF factorization.

NMF is an unsupervised learning approach that leads to parts-based feature representations. Such representations are generated using additive combinations of the original features. Also, the non-negativity constraint imposed on the factorization allows for more realistic extracted image factors (D. D. Lee and H. S. Seung, “Learning the parts of objects by non-negative matrix factorization,” Nature, vol. 401, no. 6755, pp. 788-91, 1999—incorporated herein by reference in its entirety). Given a non-negative input feature matrix, Aε [symbol] ₊^{m×n}, the NMF yields the following factorization:

A≈W×H

where the rows of Wε [symbol] ₊^{m×r}, and the columns of Hε [symbol] ₊^{r×n}, represent the NMF basis and their encoding coefficients, respectively. Feature approximation is achieved using ranks satisfying: (m+n) r<m×n. Keeping in mind that the NMF does not allow negative entries in W and H, it has found several applications including face recognition and gene expression. FIGS. 6 and 7 reveal the power of NMF factorization in terms of the locality of the features extracted. It is clear that the NMF bases are well-localized unlike the PCA ones, which gives NMF-based features more discriminality capability. The NMF factorization, defined above, defines the following optimization problem:

Given a non-negative feature matrix, Aε [symbol] ₊^{m×n}, find non-negative approximations, Wε [symbol] ₊^{m×r} and Hε [symbol] ₊^{r×n} such that r<min(m,n). Then, this non-convex constrained optimization is defined as follows:

$$f ( W , H ) = {‖ A - WH ‖}_{2}^{F} = {\sum }_{ij} {( {A}_{ij} - {( WH )}_{ij} )}^{2}$$

The Frobenius norm, ∥•∥^{F}₂, is used to measure the approximation error. Other common objective functions include the well-known Kullback-Leibler divergence (KLD) objective function:

$${D}_{KLD} ( A \vert \vert WH ) = {\sum }_{ij} ( {A}_{ij} log \frac{{A}_{ij}}{{( WH )}_{ij}} - {A}_{ij} + {( WH )}_{ij} )$$

The above equation can be solved using different algorithms including multiplicative updates, gradient descent and alternating least squares. The multiplicative updates for solving the Frobenius norm-based optimization, are given by:

$${W}_{ij} ← \frac{{( {AH}^{T} )}_{ij}}{{( {WHH}^{T} )}_{ij}} {W}_{ij}$$

$${H}_{ij} ← \frac{{( {W}^{T} A )}_{ij}}{{( {W}^{T} {WH}^{T} )}_{ij}} {H}_{ij}$$

The present invention relates to a method of predicting gas compositions in a multistage separator, particularly using an extreme learning machine in combination with an optimal feature extractor based on non-negative matrix decomposition (NMF) algorithms. Particularly, solutions to the regression problem of gas composition prediction are developed using extreme learning machines (ELMs) for defining the optimal predictor weights and non-negative matrix factorization to extract parts-based features from a set of properties of a reservoir.

The combination of ELMs and NMF is motivated by the following objectives: 1) to achieve very high prediction accuracy without resorting to parameter tuning and tedious model training; and 2) to provide noise-free and accurate, and yet realistic, features that characterize the reservoir's properties. The flexibility of ELMs allows for the consideration of kernel-based prediction which would further improve the prediction accuracy without affecting the learning efficiency in terms of computational power requirements.

Dual model and feature optimization is guaranteed by the combination of ELMs and NMF. The NMF factorization may be a pre-processing step used to further enhance the features characterizing the reservoir's properties. Efficient closed-form computation of the model weight solution eliminates the need for parameter tuning where only random initial weights are required for the input layer of the ELMs model.

In an embodiment, the invention includes a method comprising the steps of:

(a) receiving a set of input parameters related to a fluid mixture of hydrocarbons and non-hydrocarbons fed into a multistage separator;

(b) pre-processing the original features (reservoir's properties) by NMF to enhance their statistical content and remove redundant and unnecessary measurement features by selecting various factorization levels which gives a flexibility in setting the overall prediction accuracy;

(c) providing a training dataset using the reduced feature set;

(d) randomly selecting a first set percentage of the training dataset using various machine learning approaches;

(e) training the ELMs model with the selected first set percentage of the training dataset; (f) predicting a mole percentage of the non-hydrocarbons in the fluid mixture;

(g) comparing the predicted mole percentage with the input parameters and selecting a second set percentage of badly predicted training datasets based upon a pre-set threshold error value; and

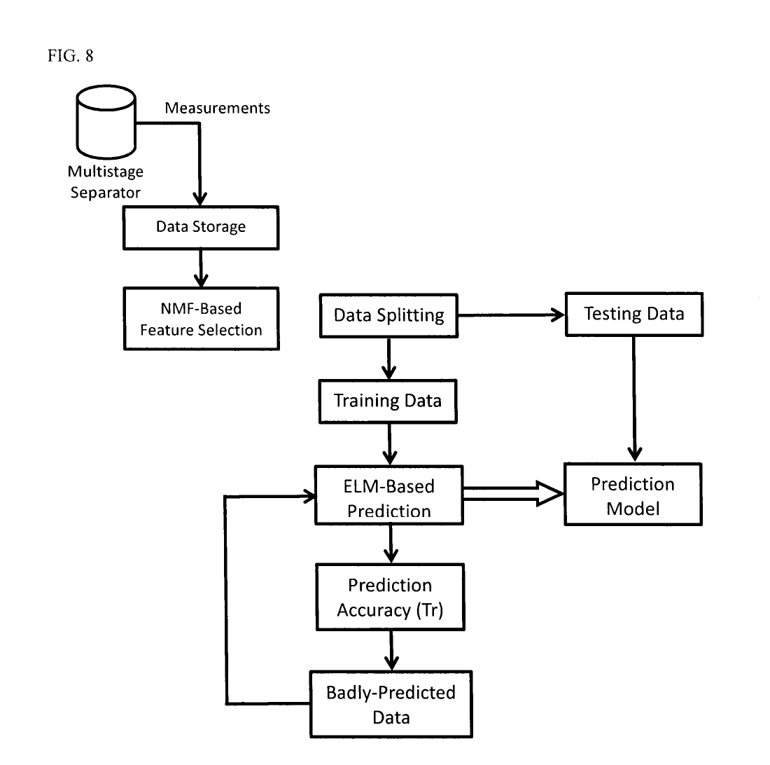

(h) repeating the steps (b) through (g) using several factorization levels in the NMF factorization on the second set percentage of badly predicted training datasets. A flowchart of an embodiment of the inventive method for the fast prediction of gas compositions is illustrated in FIG. 8.

In a preferred embodiment, the hydrocarbons comprise methane (C1), ethane (C2), propane (C3), butane (C4), pentane (C5), hexane (C6), heptanes and heavier hydrocarbons (C7+), or any combination thereof. The mole percentage of the hydrocarbons in the fluid mixture, based on the total molar amount of the fluid mixture, is preferably greater than 50%, greater than 55%, greater than 60%, greater than 65%, greater than 70%, greater than 75%, greater than 80%, greater than 85%, greater than 90%, greater than 95%, greater than 96%, greater than 97%, greater than 98%, greater than 99%, greater than 99.5%, or greater than 99.9%.

In a preferred embodiment, the non-hydrocarbons comprise N₂, CO₂, H₂S, or any combination thereof. The mole percentage of the non-hydrocarbons in the fluid mixture, based on the total molar amount of the fluid mixture, is preferably less than 50%, less than 45%, less than 40%, less than 35%, less than 30%, less than 25%, less than 20%, less than 15%, less than 10%, less than 5%, less than 4%, less than 3%, less than 2%, less than 1%, less than 0.5%, or less than 0.1%.

The reservoir temperature is preferably 100° F. to 400° F., 125° F. to 375° F., 150° F. to 350° F., 175° F. to 325° F., 200° F. to 300° F., or 225° F. to 275° F.

The reservoir pressure is preferably 500 to 6000 psi, 1000 to 5500 psi, 1500 to 5000 psi, 2000 to 4500 psi, 2500 to 4000 psi, or 3000 to 3500 psi.

The separator stage temperature in the first stage of the multistage separator is preferably 75° F. to 225° F., 100° F. to 200° F., or 125° F. to 175° F.

The separator stage pressure in the first stage of the multistage separator is preferably 50 to 300 psi, 75 to 275 psi, 100 to 250 psi, 125 to 225 psi, or 150 to 200 psi.

The separator stage temperature in the final stage of the multistage separator is preferably 45° F. to 75° F., 50° F. to 70° F., or 55° F. to 65° F.

The separator stage pressure in the final stage of the multistage separator is preferably atmospheric pressure or greater, and less than 300 psi, less than 275 psi, less than 250 psi, less than 225 psi, less than 200 psi, less than 175 psi, less than 150 psi, less than 125 psi, less than 100 psi, less than 75 psi, less than 50 psi, or less than 25 psi.

In a preferred embodiment, the set of input parameters received in step (a) is obtained by sampling process variables. The pre-processing step (b) may include one or more operations known in the art, for example performing a linear transformation of the input variables. Such a linear transformation may be useful for reducing large variations in magnitudes of the input variables, so that the transformed input variables are similar to each other in magnitude. The selecting in step (d), training in step (e), predicting in step (f), and comparing and selecting in step (g) may include one or more operations known in the art (see H. Al-Duwaish, L. Ghouti, T. Halawani, M. Mohandes, “Use of Artificial Neural Networks Process Analyzers: A Case Study,” Proceedings of the 13th European Symposium on Artificial Neural Networks, pp. 465-470, Bruges, Belgium, April 2002; L Ghouti and S. Al-Bukhitan, “Hybrid Soft Computing for PVT Properties Prediction,” Proceedings of the 18th European Symposium on Artificial Neural Networks, pp. 189-194, Bruges, Belgium, April 2010; T. Helmy, F. Anifowose and K. Faisal, “Hybrid Computational Models for the Characterization of Oil and Gas Reservoirs,” Expert Systems with Applications, vol. 37, pp. 5353-5363, July 2010; L. Ghouti and A. Owaidh, “NMF-Density: NMF-Based Breast Density Classifier,” Proceedings of the 23rd European Symposium on Artificial Neural Networks, Bruges, Belgium, April 2014—each incorporated herein by reference in its entirety).

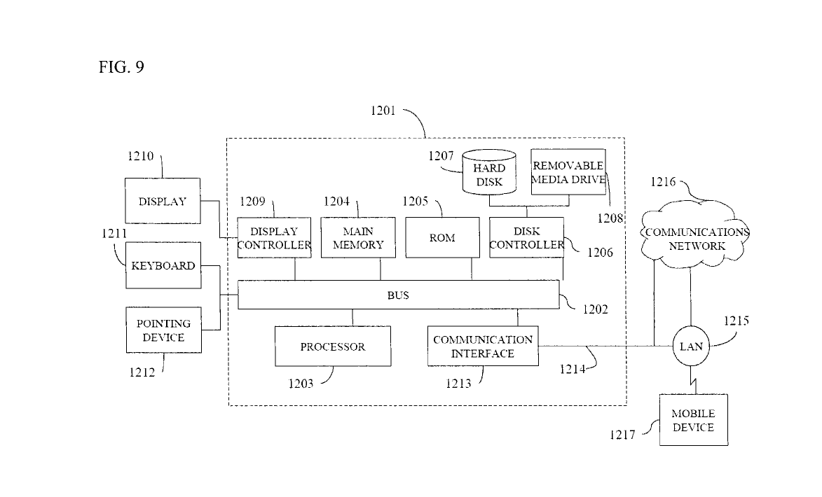

FIG. 9 illustrates a computer system 1201 upon which an embodiment of the present invention may be implemented. The computer system 1201 includes a bus 1202 or other communication mechanism for communicating information, and a processor 1203 coupled with the bus 1202 for processing the information. The computer system 1201 also includes a main memory 1204, such as a random access memory (RAM) or other dynamic storage device (e.g., dynamic RAM (DRAM), static RAM (SRAM), and synchronous DRAM (SDRAM)), coupled to the bus 1202 for storing information and instructions to be executed by processor 1203. In addition, the main memory 1204 may be used for storing temporary variables or other intermediate information during the execution of instructions by the processor 1203. The computer system 1201 further includes a read only memory (ROM) 1205 or other static storage device (e.g., programmable ROM (PROM), erasable PROM (EPROM), and electrically erasable PROM (EEPROM)) coupled to the bus 1202 for storing static information and instructions for the processor 1203.

The computer system 1201 also includes a disk controller 1206 coupled to the bus 1202 to control one or more storage devices for storing information and instructions, such as a magnetic hard disk 1207, and a removable media drive 1208 (e.g., floppy disk drive, read-only compact disc drive, read/write compact disc drive, compact disc jukebox, tape drive, and removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1201 may also include a display controller 1209 coupled to the bus 1202 to control a display 1210, such as a cathode ray tube (CRT), for displaying information to a computer user. The computer system includes input devices, such as a keyboard 1211 and a pointing device 1212, for interacting with a computer user and providing information to the processor 1203. The pointing device 1212, for example, may be a mouse, a trackball, or a pointing stick for communicating direction information and command selections to the processor 1203 and for controlling cursor movement on the display 1210. In addition, a printer may provide printed listings of data stored and/or generated by the computer system 1201.

The computer system 1201 performs a portion or all of the processing steps of the invention in response to the processor 1203 executing one or more sequences of one or more instructions contained in a memory, such as the main memory 1204. Such instructions may be read into the main memory 1204 from another computer readable medium, such as a hard disk 1207 or a removable media drive 1208. One or more processors in a multi-processing arrangement may also be employed to execute the sequences of instructions contained in main memory 1204. In alternative embodiments, hard-wired circuitry may be used in place of or in combination with software instructions. Thus, embodiments are not limited to any specific combination of hardware circuitry and software.

As stated above, the computer system 1201 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 1201, for driving a device or devices for implementing the invention, and for enabling the computer system 1201 to interact with a human user (e.g., print production personnel). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 1203 for execution. A computer readable medium may take many forms, including but not limited to, non-volatile media, volatile media, and transmission media. Non-volatile media includes, for example, optical, magnetic disks, and magneto-optical disks, such as the hard disk 1207 or the removable media drive 1208. Volatile media includes dynamic memory, such as the main memory 1204. Transmission media includes coaxial cables, copper wire and fiber optics, including the wires that make up the bus 1202. Transmission media also may also take the form of acoustic or light waves, such as those generated during radio wave and infrared data communications.

Various forms of computer readable media may be involved in carrying out one or more sequences of one or more instructions to processor 1203 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1201 may receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1204, from which the processor 1203 retrieves and executes the instructions. The instructions received by the main memory 1204 may optionally be stored on storage device 1207 or 1208 either before or after execution by processor 1203.

The computer system 1201 also includes a communication interface 1213 coupled to the bus 1202. The communication interface 1213 provides a two-way data communication coupling to a network link 1214 that is connected to, for example, a local area network (LAN) 1215, or to another communications network 1216 such as the Internet. For example, the communication interface 1213 may be a network interface card to attach to any packet switched LAN. As another example, the communication interface 1213 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc). The signals through the various networks and the signals on the network link 1214 and through the communication interface 1213, which carry the digital data to and from the computer system 1201 may be implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1201 can transmit and receive data, including program code, through the network(s) 1215 and 1216, the network link 1214 and the communication interface 1213. Moreover, the network link 1214 may provide a connection through a LAN 1215 to a mobile device 1217 such as a personal digital assistant (PDA) laptop computer, or cellular telephone.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

1. A method of predicting a gas composition, comprising:
(a) receiving a set of input parameters related to a fluid mixture of hydrocarbons and non-hydrocarbons fed into a multistage separator,
wherein:
the input parameters comprise at least one member selected from the group consisting of a reservoir temperature, a reservoir pressure, a reservoir gas composition, a separator stage temperature and a separator stage pressure, and
the non-hydrocarbons comprise at least one member selected from the group consisting of N₂, CO₂ and H₂S;
(b) pre-processing the set of input parameters by non-negative matrix factorization, with a processor, to obtain a reduced feature set;
(c) providing a training dataset comprising the reduced feature set;
(d) randomly selecting a first set percentage of the training dataset;
(e) training an extreme learning machine model with the selected first set percentage of the training dataset, with a processor;
(f) predicting a mole percentage of the non-hydrocarbons in the fluid mixture;
(g) comparing the predicted mole percentage with the set of input parameters, and selecting a second set percentage of badly predicted training datasets based upon a pre-set threshold error value; and
(h) repeating (b) through (g) one or more times on the second set percentage of badly predicted training datasets, using one or more factorization levels in the non-negative matrix factorization.

2. The method of claim 1, wherein the input parameters comprise the reservoir temperature.

3. The method of claim 2, wherein the reservoir temperature is 100° F. to 400° F.

4. The method of claim 1, wherein the input parameters comprise the reservoir pressure.

5. The method of claim 4, wherein the reservoir pressure is 500 to 6000 psi.

6. The method of claim 1, wherein the input parameters comprise the separator stage temperature.

7. The method of claim 6, wherein the separator stage temperature is a temperature of a first stage of the multistage separator, and is 75° F. to 225° F.

8. The method of claim 1, wherein the input parameters comprise the separator stage pressure.

9. The method of claim 8, wherein the separator stage pressure is a pressure of a first stage of the multistage separator, and is 50 to 300 psi.

10. A gas composition predicting device, comprising:
an interface; and
circuitry configured to
(a) receive a set of input parameters related to a fluid mixture of hydrocarbons and non-hydrocarbons fed into a multistage separator via the interface,
wherein:
the input parameters comprise at least one member selected from the group consisting of a reservoir temperature, a reservoir pressure, a reservoir gas composition, a separator stage temperature and a separator stage pressure, and
the non-hydrocarbons comprise at least one member selected from the group consisting of N₂, CO₂ and H₂S;
(b) pre-process the set of input parameters by non-negative matrix factorization, with a processor, to obtain a reduced feature set;
(c) provide a training dataset comprising the reduced feature set;
(d) randomly select a first set percentage of the training dataset;
(e) train an extreme learning machine model with the selected first set percentage of the training dataset, with a processor;
(f) predict a mole percentage of the non-hydrocarbons in the fluid mixture;
(g) compare the predicted mole percentage with the set of input parameters, and select a second set percentage of badly predicted training datasets based upon a pre-set threshold error value; and
(h) repeat (b) through (g) one or more times on the second set percentage of badly predicted training datasets, using one or more factorization levels in the non-negative matrix factorization.

11. The device of claim 10, wherein the input parameters comprise the reservoir temperature.

12. The device of claim 11, wherein the reservoir temperature is 100° F. to 400° F.

13. The device of claim 10, wherein the input parameters comprise the reservoir pressure.

14. The device of claim 13, wherein the reservoir pressure is 500 to 6000 psi.

15. The device of claim 10, wherein the input parameters comprise the separator stage temperature.

16. The device of claim 15, wherein the separator stage temperature is a temperature of a first stage of the multistage separator, and is 75° F. to 225° F.

17. The device of claim 10, wherein the input parameters comprise the separator stage pressure.

18. The device of claim 17, wherein the separator stage pressure is a pressure of a first stage of the multistage separator, and is 50 to 300 psi.
